(19) United States
(12) Patent Application Publication
(10) Pub. No.: US 2008/0077631 A1
(43) Pub. Date: Mar. 27, 2008

(54) MULTI-DOCUMENT ATTRIBUTE SYNCHRONIZATION IN A CONTENT MANAGEMENT SYSTEM

(76) Inventor: John E. Petri, Lewiston, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/533,790

(22) Filed: Sep. 21, 2006

(51) Int. Cl. G06F 17/30

(52) U.S. Cl. 707/204

(57) ABSTRACT

Embodiments of the invention provide a method, system and article of manufacture for synchronizing multi-document attributes in data objects managed by a content management system (CMS). Generally, when a document is checked into or out of the CMS, document attributes may be synchronized; maintaining document consistency for multi-document attributes across multiple documents.

### BACKGROUND OF THE INVENTION

1. Field of the Invention

Embodiments of the invention are generally related to processing content stored in a Content Management System (CMS). More specifically, embodiments of the invention are related to synchronizing attributes present in multiple data objects managed by a CMS.

2. Description of the Related Art

Content management systems (CMS) allow multiple users to share information. Generally, a CMS system allows users to create, modify, archive, search, and remove data objects from an organized repository. The data objects managed by CMS may include documents, spreadsheets, database records, digital images and digital video sequences. A CMS typically includes tools for format management, revision and/or access control, along with tools for document indexing, searching, and retrieval.

One useful feature provided by some CMS systems allows users to synchronize attributes or content stored in a data object with attributes about the data object maintained by the CMS. For example, a CMS attribute specifying a version or state (e.g., draft, final, approved, etc.) for a given document may be synchronized with metadata or content embedded in the document itself. Often data objects in the CMS may be stored and processed as XML documents, and the XML markup may include attributes corresponding to ones maintained and synchronized by the CMS.

To support advanced XML data management, a CMS may employ extra processing rules governing content that flows into or out of a repository (a collection of documents managed by the CMS). These rules may include rules for synchronizing XML content (e.g. element or attribute values) and CMS document metadata. For example, a synchronization rule might be defined that specifies whenever a CMS attribute is changed (e.g., version) a particular piece of XML in the content should be automatically updated with that attribute's value. These synchronization rules ensure that document content and CMS attributes are kept in synch with one another.

While this technique allows CMS attributes and document metadata to remain consistent between a given document and the CMS itself, it fails to address synchronization of attributes and/or content across multiple documents. However, XML grammars frequently include mechanisms for one document to reference external files, objects, and/or other XML documents. The creation or update of those files often depends on attributes from a root, or parent, document. Generally, any number of related files (not necessarily parent/child relationships) could have this problem.

A good example occurs in the field of regulatory compliance where regulating agencies or organizations publish XML grammars used by industry participants. For example, in the pharmaceutical industry, the International Conference on Harmonisation of Technical Requirements (ICH) has published a standard set of XML files for governing electronic drug submissions to the FDA (commonly referred to as the eCTD—electronic common technical document). Fundamentally, the eCTD is an XML backbone that references additional supporting documents. However, some of those supporting documents contain information that is logically associated with attributes in the parent or root document of the eCTD backbone. Thus, some data elements are present in two locations; the root document of the eCTD backbone and one or more child documents. More generally, this situation occurs whenever two or more related documents include content or attributes that needs to be synchronized. Further, the attributes or content of the two or more related documents may also appear in information maintained by the CMS.

Accordingly, there remains a need in the art for multi-document attribute synchronization in a content management system.

### SUMMARY OF THE INVENTION

Embodiments of the invention provide a method of synchronizing a multi-document attribute common to at least a first document and a second document. The method generally includes, identifying the first document, wherein the first document is related to the second document, and wherein access to the first document and the second document is managed by a content management system (CMS). The method also includes determining at least one synchronization rule associated with the first document, wherein the synchronization rule specifies a rule for synchronizing the multi-document attribute and, based on the rule, synchronizing value(s) of the multi-document attribute in the first document with a corresponding attribute or content in the second document.

In a particular embodiment, the first document is a parent document containing links to one or more child documents and the multi-document attribute is an attribute of the parent document referenced by each of the one or more child documents. Also, the first document may be identified as the subject of a request to check-out the first document from the CMS by a client application. Alternatively, the first document may be identified as the subject of a request to check-in a document into the CMS.

Embodiments of the invention also provide a computer-readable storage medium containing a program which, when executed, performs an operation for synchronizing a multi-document attribute common to at least a first document and a second document. The operation generally includes identifying the first document, wherein the first document is related to the second document, and wherein access to the first document and the second document is managed by a content management system CMS. The operation also includes determining at least one synchronization rule associated with the first document, wherein the synchronization rule specifies a rule for synchronizing the multi-document attribute, and based on the rule, synchronizing a value of the multi-document attribute in the first document with a corresponding attribute or content portion of the second document.

Embodiments of the invention further provide a system having a processor and a memory containing a CMS configured to perform a method for synchronizing a multi-document attribute common to at least a first document and a second document. The method generally includes, identifying the first document, wherein the first document is related to the second document, and wherein access to the first document and the second document is managed by a CMS. The method also includes determining at least one synchronization rule associated with the first document, wherein the synchronization rule specifies a rule for synchronizing the multi-document attribute and, based on the rule, synchronizing a value of the multi-document attribute in the first document with a corresponding attribute or content portion of the second document.

Embodiments of the invention still further provide a method of synchronizing a multi-document attribute common to at least a first document and a second document, wherein the first document is related to the second document. The method generally includes receiving a request regarding the first document, wherein access to the first document and the second document is managed by a CMS and the request is one of a request to check-in the first document to the CMS and a request to check-out the first document from the CMS by a client application. Responsive to the request, this method also includes synchronizing a value of the multi-document attribute in the first document with a corresponding value of the multi-document attribute in the second document; wherein the synchronizing is based on a synchronization rule associated with the first document.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment and content management system, according to one embodiment of the invention.

FIG. 2 is a block diagram illustrating a client application used to access data objects from a CMS, according to one embodiment of the invention.

FIG. 3 shows examples of XML documents stored by a CMS, including a child document that references attributes in a parent document, and the parent document having links to the child document, according to one embodiment of the invention.

FIG. 4 is a flow diagram illustrating a method for multi-document attribute to content synchronization in a content management system, according to one embodiment of the inveniton.

### DETAILED DESCRIPTION OF THE PREFERRED EMBODIMENTS

Embodiments of the invention provide a method, system and article of manufacture for synchronizing multi-document attributes in data objects managed by a content management system (CMS). In a particular embodiment, when documents are checked into or out of the CMS, document attributes and/or document content may be synchronized; maintaining document consistency for the document attributes across multiple documents. As used herein, synchronization generally refers to a process of replicating information in one location (e.g., attributes present in a parent document) to the same information in other locations (e.g. attributes present in child document or a CMS attribute table). Without synchronization, related documents being managed by the CMS could contain inconsistent values.

In one embodiment, users may define synchronization rules specifying how multi-document attributes should be synchronized. For example, a synchronization rule may specify that document metadata in a child document should be synchronized with values from a parent document. Further, when creating a new document, the CMS may be configured to prompt a user to supply values for synchronized attributes and to populate multiple documents with the supplied values. For example, when a user selects to create a document having a parent/child structure recognized by the CMS, child documents may be created with synchronized attributes automatically.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD- or DVD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Embodiments of the invention are described herein adapted for use with the widely used XML markup language. Accordingly, references to data objects, documents, and XML documents generally refers to data marked up using a well-formed collection of XML tags, elements and/or attributes. As is known, an XML grammar may be used to describe virtually any type of data. For example, XML grammars have been used to describe word processing documents, spreadsheets, database records, digital images and digital video, to name but a few. Further, specialized grammars are frequently specified for use with a domain specific XML schema (e.g., the eCTD XML schemas). An XML schema may be used to describe domain-specific data objects, such as rules regarding the structure, content, attributes, or semantics of a particular document type. However, the invention is not limited to the XML markup language, XML schemas, and the use of XML documents; rather, embodiments of the invention may be adapted to other markup languages, data object formats or data representations, whether now known or later developed.

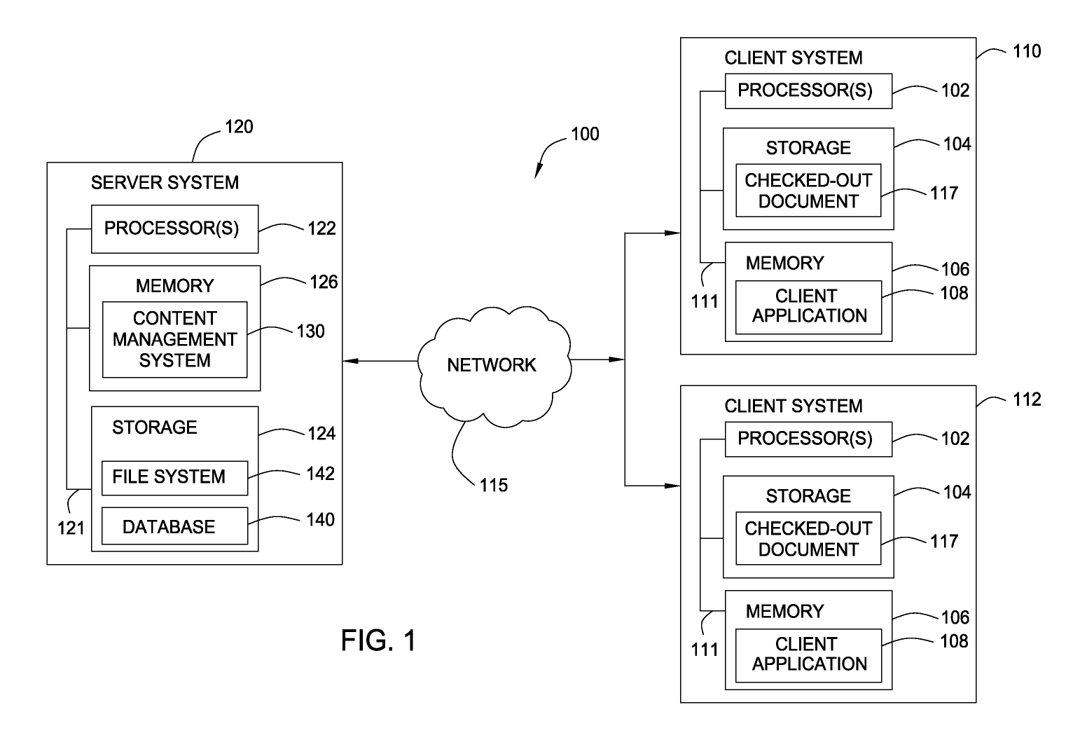

FIG. 1 is a block diagram that illustrates a client/server view of a computing environment 100, according to one embodiment of the invention. As shown, computing environment 100 includes two client computer systems 110 and 112 communicating with a server system 120 over a network 115. The computer systems 110, 112, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustration of computer systems 110, 112, and 120 are simplified to highlight aspects of the present invention and that computing systems and networks typically include a variety of additional elements not shown in FIG. 1.

As shown, client computer systems 110 and 112 each include a CPU 102, storage 104, and memory 106 connected by a bus 111. CPU 102 is a programmable logic device that performs all the instructions, logic and mathematical processing performed in executing user applications (e.g., a client application 108). Storage 104 stores application programs and data for use by client computer systems 110 and 112. Typical storage devices 104 include hard-disk drives, flash memory devices, optical media and the like. Additionally, the processing activity and access to hardware resources made by client application 108 may be coordinated by an operating system (not shown). Well known examples of operating systems include the Windows® operating system, distributions of the Linux® operating system, among others. (Linux is a trademark of Linus Torvalds in the US, other countries, or both). Network 115 represents any kind of data communications network, including both wired and wireless networks. Accordingly, network 115 is representative of both local and wide area networks, including the Internet.

Illustratively, memory 106 of client computer systems 110 and 112 includes a client application 108. In one embodiment, client application 108 is a software application that allows end users to retrieve and edit data objects stored in a content management system (CMS) 130. Thus, client application 108 may be configured to allow users to create, edit, and save a data object, e.g., word-processing documents, spreadsheets, database records, digital images or video data objects, to name but a few (collectively referred to as a “documents”). In one embodiment, client application 108 may be configured to receive a document 117 from CMS 130 and store it in storage 104 while it is being accessed by client application 108.

Documents accessed from CMS 130 may be marked up using XML elements to describe the underlying data contained within the document for use with a particular client application 108, relative to an associated XML schema. Additionally, in one embodiment, a set of content synchronization rules may be defined for a particular document type, and whenever a document of that type flows into or out of the repository, the rules may be used to synchronize attributes or elements of the document with related documents in the repository. Some synchronization rules may be directed to a parent document while other rules may be directed to its constituent children. Additionally, when a new document is created, e.g., a new parent or root document, CMS 130 may prompt the user to specify values for a set of attributes that will be synchronized for a set of related child documents. In other words, the synchronization attributes for a related set of documents may be synchronized when the parent document is initially created. Thereafter, anytime the parent document, or any of its related child documents moves into or out of a CMS repository 124, the synchronization rules may be used to ensure that the content and/or attributes subject to the synchronization rules have the correct values.

Server system 120 also includes a CPU 122, CMS storage repository 124, and a memory 126 connected by a bus 121. CMS repository 124 may include a database 140 and file system 142. File system 142 typically provides access to a directory structure contained on a disk drive or network file system and may be used to store files (e.g., documents managed by CMS 130). Database 140 may contain additional information and metadata related to documents stored in file system 142. Memory 126 of server system 120 includes CMS 130. As stated, CMS 130 may provide an application program configured for creating, modifying, archiving, and removing content managed by CMS 130. Thus, CMS 130 may include tools used for publishing, format management, revision and/or access control, content indexing, and facilities for performing searches and other operations related to documents managed by CMS 130.

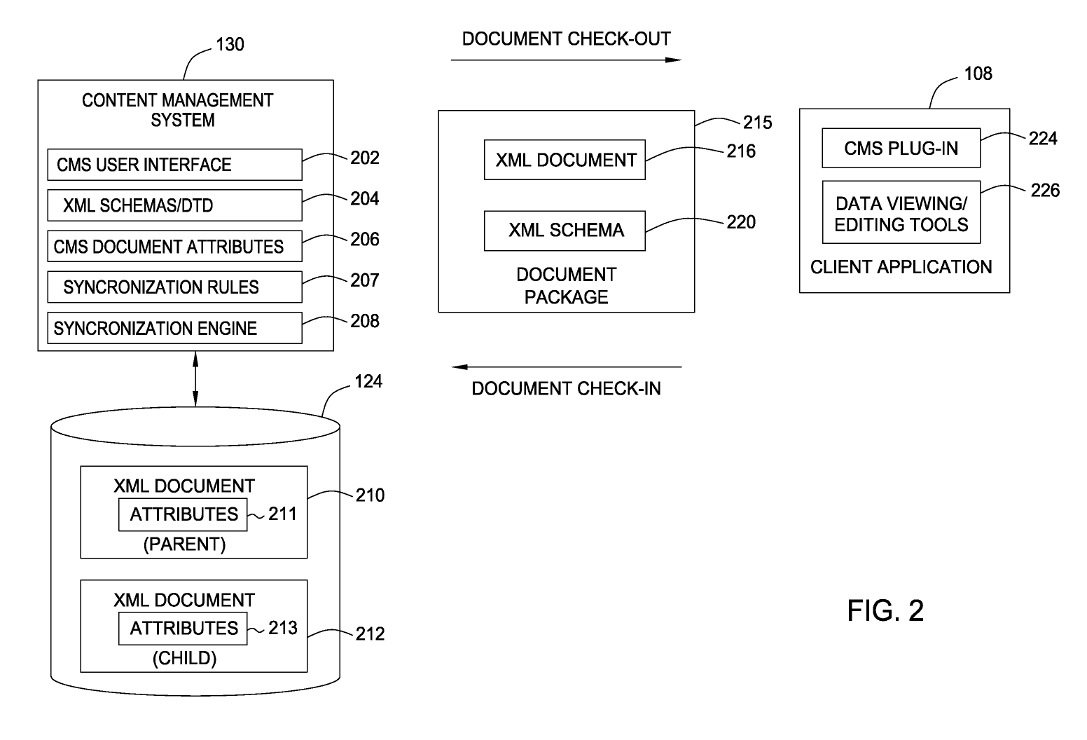

FIG. 2 is a block diagram illustrating a client application used to access data objects from a CMS, according to one embodiment of the invention. As shown, CMS 130 includes a user interface 202, XML schemas/DTDs 204, CMS document Attributes 206, synchronization rules 207, and multi-document synchronization engine 208. Those skilled in the art will recognize that the CMS 130 illustrated in FIG. 2 is simplified to highlight aspects of the present invention and that a CMS system typically includes a variety of additional elements not shown in FIG. 2. Although shown as part of CMS 130, in one embodiment, schemas/DTDs 204 and synchronization rules 207 may be stored as documents in repository 124.

Generally, user interface 202 provides an interface to the functions provided by CMS 130 and content stored by database 140 and file system 142. Thus, user interface 202 may provide mechanisms for checking in/out a document from CMS 130, for specifying synchronization rules 206, for creating, viewing, and exporting documents from CMS 130 etc. XML schema/DTDs 204 provide a description of the allowed content and structure of a given type of XML document.

More specifically, schemas/DTDs 204 provide rules specifying which elements (e.g., the markup tags) and attributes (i.e., values associated with specific tags) are allowed in a particular type of XML document. CMS document attributes 206 specify information maintained by the CMS about documents stored in CMS repository 124. For example, the CMS document attributes may maintain information such as a document ID, document version, revision history, author, access control rules and the like. In one embodiment, document attributes 206 may also specify what synchronization rules should be applied to a given document managed by the CMS.

Synchronization rules 207 may specify which elements, attributes or content should be synchronized between related documents. In one embodiment, an XML schema may provide the definitions and conventions used to create a set of synchronization rules for a particular document type. Generally, the rules schema provides a framework for a CMS administrator to compose synchronization rules for documents managed by CMS 130. Thus, the rules schema may define elements allowing the administrator to map content to CMS attributes and CMS attributes to content in an XML document.

Synchronization engine 208 may be configured to synchronize content across multiple documents according to the synchronization rules 207 that are appropriate for a given document type. For example, CMS repository 124 is shown to include a parent document 210 and a child document 212. Also, the parent document includes attributes 211 and the child document 212 includes attributes 213. Assume that synchronization rules 207 include a rule specifying that attributes 211 and 213 should be synchronized using the values from parent document 210. In such a case, when child document 212 or parent document 210 is checked out, synchronization engine 208 may be used to synchronize the values of attributes 213 (the attributes of parent document 210) with those in attributes 211 (the attributes of child document 212).

As another example, attributes 211 from parent document 210 may be synchronized with the content of child document 212. For example, when a new eCTD root document is created, the eCTD “backbone” is the parent document, and CMS attributes entered by the user to create the eCTD backbone document may be used to generate portions of the content for the child documents, e.g., XML elements, attributes, etc. within the child document.

FIG. 2 also shows document package 215 being checked out/in from the CMS 130 for use by client application 108. In one embodiment, when a document flows into or out of repository 124, the CMS may be configured to synchronize multi-document attributes. On document check-out, after any synchronization actions are completed, the CMS may package XML document 216 and an associated XML schema 220 and transmit document package 215 to client application 108.

On document check-in, CMS 130 may be configured to process the XML document 216 using any applicable synchronization rules. CMS 130 may be configured to synchronize documents in the repository 124 based on modifications made to a document when it is checked back in. For example, if attributes 211 are modified while document 210 is checked out, the synchronization engine 207 may be configured to update corresponding attributes 213 of child document 212 when parent document 210 is checked back into CMS 130. Conversely, if child document 210 is checked out and modified, changes to attributes 213 made by client application 108 may be overwritten by synchronization engine 207. Alternatively, instead of always using the values of attributes 211 during synchronization, a rule 207 could specify to always use the most recent value, in which case the attributes 213 of child document 212 would be synchronized to the attributes 213 of parent document 210. Of course, the actual behavior of synchronization rules 207 may be tailored to suit the needs of a particular case.

As shown, client application 108 includes CMS plug-in 224 and data viewing and editing tools 226. CMS plug-in 224 allows client application 108 to interact with CMS 130. For example, plug-in 224 may allow a user interacting with client application 108 to check-in and check-out documents (e.g., document package 215) from CMS 130. Editing tools 226 provide the substantive features associated with a particular client application. For example, a word processing application may provide tools for specifying document presentation style or a web-browser may be used to render, view, and update XML document 216. Of course, depending on the function of client application 108, the exact features provided by viewing/editing tools 226 will vary.

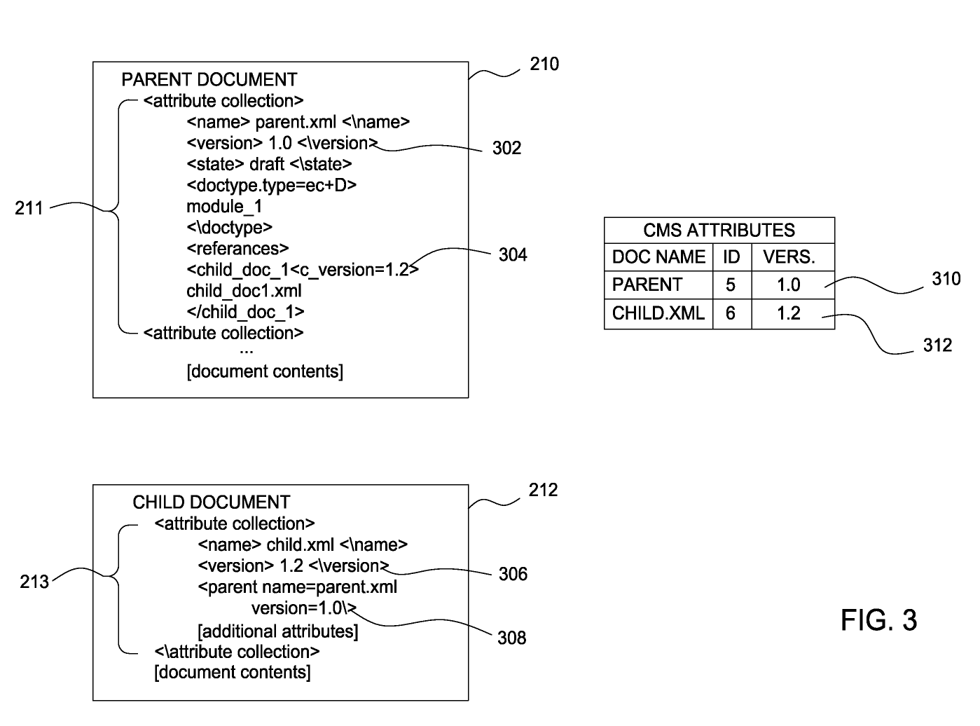

FIG. 3 illustrates an example of parent document 210 and child document 212. As shown, the attributes 211 include a version 302 of “1.0” and a reference 304 to a child document. The <child_doc_{—}1>element includes an attribute “c_version” specifying the current version “1.2” of the referenced child document. Similarly, the attributes 213 of child document 212 include a version 306 for the child document of “1.2” and a “parent” name element 308 that includes attributes specifying the name and version of the parent document of “parent.xml” and “1.0.” Additionally, CMS attributes 206 include rows 310 and 312 in which the name and version values are also recorded. In one embodiment, whenever either parent document 210 or child document 212 are checked into or out of the CMS repository 124, the synchronization engine 208 may process rules 207 to synchronize content and/or attributes in the parent document 210, child document 212 and/or CMS attributes 206.

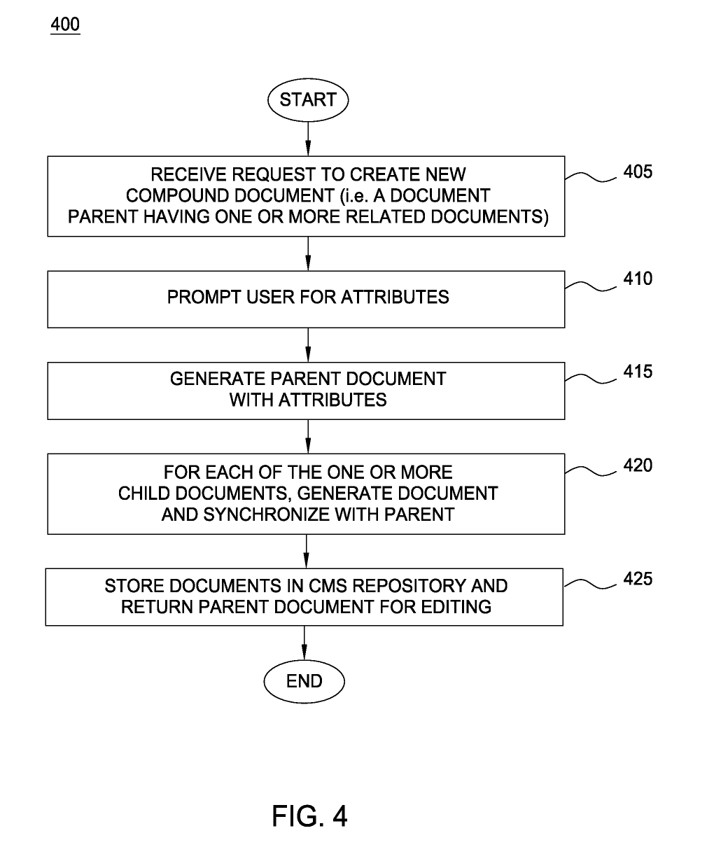

FIG. 4 is a flow diagram illustrating a method 400 for multi-document attribute to content synchronization in a content management system, according to one embodiment of the invention. The method 400 begins at step 405 where the CMS 130 receives a request to create a new compound document. That is, a document parent having references to one or more related documents.

At step 410, the user may be prompted to supply the attributes for the new document to be generated. Simple examples of attributes include document name, initial version, document owner, and the like. Of course, the type of attributes prompted for will depend on the document type being generated and what synchronization rules have been created. In one embodiment, CMS 130 may prompt a user to supply values for attributes that will be synchronized between a parent document (e.g., the backbone of an eCTD) and a collection of related child documents (e.g., the individual modules of the eCTD referenced by the backbone).

At step 415, the parent document may be generated using the supplied attributes. The CMS 130 may also synchronize CMS attributes 206 with values taken from the parent document. At step 420, the collection of one or more child documents associated wit the particular parent document type may be generated. Additionally, the synchronization engine 207 may use the relevant synchronization rules 208 to synchronize elements of the child documents with the parent document. At step 425, the collection of one or more child documents generated in step 415 may be stored in the CMS repository 124 and the parent document may be returned to the client application 108 for editing by the user.

Advantageously, embodiments of the invention allow for attribute synchronization across multiple documents. Multi-document attribute synchronization is often needed because XML document grammars include references for external files, but creating or updating the files often depends on attributes from the root, or parent document.

While the foregoing is directed to embodiments of the present invention, other and further embodiments of the invention may be devised without departing from the basic scope thereof, and the scope thereof is determined by the claims that follow.

What is claimed is:

1. A method of synchronizing a multi-document attribute common to at least a first document and a second document, comprising:
identifying the first document, wherein the first document is related to the second document, and wherein access to the first document and the second document is managed by a content management system (CMS);
determining at least one synchronization rule associated with the first document, wherein the synchronization rule specifies a rule for synchronizing the multi-document attribute, and;
based on the rule, synchronizing a value of the multi-document attribute in the first document with a corresponding value of the multi-document attribute in the second document.

2. The method of claim 1, wherein the first document is a parent document containing links to one or more child documents, and wherein the multi-document attribute is an attribute of the parent document synchronized with document content in one or more of the child documents.

3. The method of claim 2, wherein the parent document and each of the child documents are marked up using an XML grammar.

4. The method of claim 1, wherein identifying a first document comprises receiving a request to check-out the first document from the CMS by a client application.

5. The method of claim 1, wherein identifying the first document comprises receiving a request to check-in the first document into the CMS.

6. The method of claim 1, wherein the multi-document attribute common to the first document and the second document is reflected as a metadata attribute in the first document, and reflected as content of the second document.

7. The method of claim 1, further comprising synchronizing document metadata maintained by the CMS with synchronizing the value of the multi-document attribute.

8. A computer-readable storage medium containing a program which, when executed, performs an operation for synchronizing a multi-document attribute common to at least a first document and a second document, the operation comprising:
identifying the first document, wherein the first document is related to the second document, and wherein access to the first document and the second document is managed by a content management system (CMS);
determining at least one synchronization rule associated with the first document, wherein the synchronization rule specifies a rule for synchronizing the multi-document attribute, and;
based on the rule, synchronizing a value of the multi-document attribute in the first document with a corresponding value of the multi-document attribute in the second document.

9. The computer-readable storage medium of claim 8, wherein the first document is a parent document containing links to one or more child documents, and wherein the multi-document attribute is an attribute of the parent document synchronized with document content in one or more of the child documents.

10. The computer-readable storage medium of claim 9, wherein the parent document and each of the child documents are marked up using an XML grammar.

11. The computer-readable storage medium of claim 8, wherein identifying a first document comprises receiving a request to check-out the first document from the CMS by a client application.

12. The computer-readable storage medium of claim 8, wherein identifying the first document comprises receiving a request to check-in the first document into the CMS.

13. The computer-readable storage medium of claim 8, wherein the multi-document attribute common to the first document and the second document is reflected as a metadata attribute in the first document, and reflected as content of the second document.

14. The computer-readable storage medium of claim 8, wherein the operation further comprises synchronizing document metadata maintained by the CMS with synchronizing the value of the multi-document attribute.

15. A system, comprising:
a processor; and
a memory containing a content management system (CMS) configured to perform a method for synchronizing a multi-document attribute common to at least a first document and a second document, comprising:
identifying the first document, wherein the first document is related to the second document, and wherein access to the first document and the second document is managed by the CMS;
determining at least one synchronization rule associated with the first document, wherein the synchronization rule specifies a rule for synchronizing the multi-document attribute, and;
based on the rule, synchronizing a value of the multi-document attribute in the first document with a corresponding value of the multi-document attribute in the second data object.

16. The system of claim 15, wherein the first document is a parent document containing links to one or more child documents, and wherein the multi-document attribute is an attribute of the parent document synchronized with document content in one or more of the child documents.

17. The system of claim 16, wherein the parent document and each of the child documents are marked up using an XML grammar.

18. The system of claim 15, wherein identifying a first document comprises receiving a request to check-out the first document from the CMS by a client application.

19. The system of claim 15 wherein identifying the first document comprises receiving a request to check-in the first document into the CMS.

20. The system of claim 15, wherein the multi-document attribute common to the first document and the second document is reflected as a metadata attribute in the first document, and reflected as content of the second document.

21. The system of claim 15, wherein the CMS is further configured to synchronize document metadata maintained by the CMS with synchronizing the value of the multi-document attribute.

22. A method of synchronizing a multi-document attribute common to at least a first document and a second document, wherein the first document is related to the second document, the method comprising:
receiving a request regarding the first document, wherein access to the first document and the second document is managed by a content management system (CMS) and the request is one of a request to check-in the first document to the CMS and a request to check-out the first document from the CMS by a client application; and
responsive to the request, synchronizing a value of the multi-document attribute in the first document with a corresponding value of the multi-document attribute in the second document; wherein the synchronizing is based on a synchronization rule associated with the first document.
